(19) United States
(12) Patent Application Publication
(10) Pub. No.: US 2004/0153810 A1
(43) Pub. Date: Aug. 5, 2004

(54) Computer system equipped with a BIOS debugging card

(76) Inventor: Hung-Yu Kuo, Hsin-Tien City (TW)

Correspondence Address: RABIN & Berdo, PC, 1101 14TH STREET, NW, SUITE 500, WASHINGTON, DC, 20005, US

(21) Appl. No.: 10/608,097

(22) Filed: Jun. 30, 2003

(30) Foreign Application Priority Data
Oct. 25, 2002 (TW) 91125207

(51) Int. Cl. H04L 1/22

(52) U.S. Cl. 714/36

(57) ABSTRACT

A method of initializing a computer system equipped with a debugging system. The computer system has a CPU, a local, peripheral and expansion bus, a first and second bridge, and a ROM coupled to the expansion bus and store a first BIOS code, and the debugging system is coupled to the peripheral bus. The method including the steps of operating the CPU in a normal mode wherein first data requests directed to the ROM are routed to the local bus by the CPU, operating the CPU in a debugging mode wherein second data requests directed to the debugging system are routed to the local bus bye the CPU, transferring the first or second data requests from the local bus to the peripheral bus by the first bridge, responding by the second bridge or debugging system to the data requests with the first or second BIOS code to be loaded in the CPU according to the direction of the data request.

### BACKGROUND OF THE INVENTION

1. Field of the Invention

The present invention relates to a computer system and a corresponding method, and particularly to a computer system supporting insertion of a BIOS debugging card and a corresponding method of the computer. Moreover, the system can be initialized through the debugging card in the event of a ROM BIOS failure.

2. Description of the Prior Art

The architecture of most computers is generally defined by functional layers. The lowest layer is the hardware or machine layer. The highest layer is the application program that interfaces with a user. In between the hardware and application program is the system software. The system software itself may be composed of several elements, including: the operating system kernel and shell, device drivers, and, perhaps, a multitasking supervisor.

Most architectures also include a low-level software layer between the hardware and the system software, or Basic Input/Output System (BIOS). The BIOS provides primitive I/O services, allowing the system and application software to communicate with the hardware by issuing interrupts. Most computing systems are controlled through the use of interrupts. Interrupts can be generated by the microprocessor, by the system hardware, or by software. The BIOS provides a logical handling of the interrupt signals. When an interrupt occurs, control of the computer is transferred to an interrupt vector which defines the “segment:offset” address of the routing in BIOS assigned to the given interrupt number.

BIOS Interrupt Service Routines (ISRs) handle interrupts issued by hardware devices. ISRs use registers in the microprocessor and BIOS data areas. The BIOS Device Service Routines (DSRs) handle software interrupts issued by the INT instruction.

In addition to providing the previously described run-time services, the BIOS should be enabled to initialize and configure the computer when the computer is first routed on. The BIOS runs a startup program called the POST program, which performs a number of tasks, including testing random access memory (RAM), conducting an inventory of the hardware devices installed in the computer, configuring hard and floppy disks, keyboard, and serial and parallel ports, configuring other devices installed in the computer such as CD-ROM drives and sound cards, initializing computer hardware required for computer features such as Plug and Play and Power Management, and running setup if requested.

If prior tasks are successful, the Operating System such as DOS, OS/2, UNIX, or Windows '95 is then loaded by the BIOS.

Since the initialization and configuration of the computer system are complicated, the BIOS or operation system possibly fails to be started due to malfunctions or bugs, especially for the BIOS. Accordingly, chipset manufacturers, the main designers of BIOS, are compelled to concentrate effort in debugging the BIOS code.

During debugging of the BIOS, there is an embarrassing situation that the whole system is halted due to any BIOS error, which make it impossible to debug the BIOS code through the computer system itself. The debugging of the BIOS is conventionally done by logic analysis directly measuring the signals on pins of the chips. This is a time-consuming work.

### SUMMARY OF THE INVENTION

The object of the present invention is to provide a computer system supporting insertion of a BIOS debugging card, wherein the whole system can be initialized through the debugging card even if ROM BIOS fails.

The present invention provides a method of initializing a computer system equipped with a debugging system, wherein the computer system has a CPU, a local, peripheral and expansion bus, a first and second bridge, and a ROM coupled to the expansion bus and storing first BIOS code, and the debugging system is coupled to the peripheral bus. The method comprises the following steps of normal CPU operation, wherein first data requests directed to the ROM are routed to the local bus by the CPU, when operating in a debugging mode the CPU directs second data requests to the debugging system and routes requests to the local bus. The first or second data requests are transferred from the local bus to the peripheral bus via the first bridge. The second bridge responds to the first data requests on the peripheral bus with the first BIOS code stored in ROM to be loaded in the CPU, and responds to the debugging system with the second BIOS code stored therein to be loaded in the CPU.

The present invention further provides a computer system capable of being initialized by a debugging system, comprising a CPU switched between a normal mode wherein first data requests directed to the ROM are routed to the local bus by the CPU and a debugging mode wherein second data requests directed to the debugging system are routed to the local bus by the CPU, a local, peripheral and expansion bus, wherein the CPU drops first or second data requests to the local bus and the debugging system is coupled to the peripheral bus, a ROM coupled to the expansion bus and storing first BIOS code, to which the first data requests are directed, a first bridge transferring the first or second data requests from the local to the peripheral bus, and a second bridge responding the first data requests on the peripheral bus with the first BIOS code in the ROM to be loaded in the CPU.

Accordingly, by using a switch to enable or disable the A20 gate of the CPU, the invention can modify the address of the data requests from the CPU and route the data requests to the debugging system. Therefore, the BIOS on the ROM can be ignored and the computer is started by the debugging system, and then it is possible to analysis and/or correct the errors of the BIOS.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing a computer system equipped with a BIOS debugging card according to one embodiment of the invention.

FIG. 2 is a diagram showing timing of the signals used in the computer system of FIG. 1.

### DETAILED DESCRIPTION OF THE INVENTION

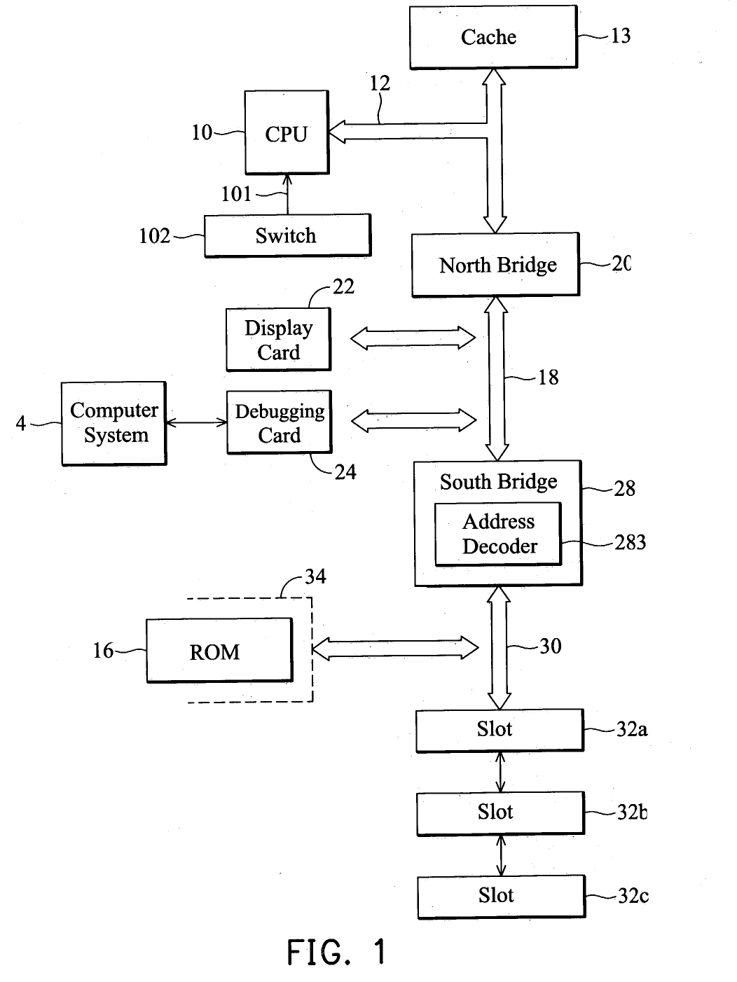

Referring now to FIG. 1, a personal computer system equipped with a debugging system is shown with the components being represented in block diagram form. The various components and buses of the computer system are typically formed on a system board or motherboard, which are well known and thus not shown. The motherboard provides the necessary wiring, card slots and other connections and various circuit components, such as capacitors and resistors, to form the system. A personal computer system typically contains a CPU 10, based on a microprocessor such as an Intel Pentium 4. The CPU 10 is connected to a CPU local bus 12, which also may have cache memory 13 connected thereto.

The CPU 10 has a specific A20 gate 101. Employment of the A20 gate is explained in the following. Early CPUs, such as the 8086, have an address space limit of 1M byte, thus the CPU provides only 20 address lines A0˜A19. When an address line reaches full capacity, data stored therein begins to populate the next address line (which is usually called as wrap around). Newly designed computer systems provide a 16M byte address space and use a CPU, such as the 80286, which provides 24 address lines. For the sake of compatibility between existing software written for earlier microprocessors, and newer computer systems, a CPU must be able to operate in two modes, a real mode, and a protected mode. In protected mode, the CPU emulates earlier CPUs by disabling the A20 gate (i.e., the output of the address line A20 is always 0) to limit the address space to 1M byte. The latest microprocessors, however, such as the Intel Pentium 4, only operate in real mode wherein the A20 gate is always enabled.

In order to route a data request, originally directed to ROM, to the debugging system, a switching signal is input to the A20 gate. When the switching signal is activated by a switch 102, the A20 gate is disabled and the address output from the address lines A20 is set to 0. The forcedly altered address is assigned to the debugging system. Thus, the CPU may operate in a debugging mode wherein the data request originally directed to the ROM is routed to. the debugging system. Conversely, if the data request is not routed to the debugging system, the CPU will operate normally with the A20 gate enabled.

The local CPU bus 12 is connected to a peripheral bus 18, which in the preferred embodiment is the peripheral controller interconnect (PCI) bus, by the memory controller/peripheral bus host bridge (MC/PBHB) logic chip 20, known as the “north bridge”.

Various devices, such as a video device 22, can be connected to the peripheral bus. 18. An interface card 24 for interconnecting the computer system with another computer system 4 for debugging is also connected to the peripheral bus 18.

The PCI bus 18 is connected through the PCI-to-expansion bus bridge 28, known as the “south bridge”, to an expansion bus 30. The expansion bus 30 can be either a bus incorporating Micro Channel architecture or an ISA bus. The south bridge 28 has an address decoder 283 for the ROM 16, such as for decoding the addresses of the ROM 16. When CPU 10 drops a data request directed to the ROM 16, the PCI to expansion bus bridge 28 handles the reading of the ROM 16 so that the CPU will read the data from the ROM 16 on the expansion bus through both the PCI to expansion bus bridge 28 and the MC/PBHB logic chip 20.

Various slots 32a, 32b and 32c, are provided for connecting different devices to the expansion bus 30. Additionally, a slot 34 for connecting card 15 having ROM 16 is provided on the expansion bus 30. The ROM 16 stores the BIOS code having the initialization instructions or code.

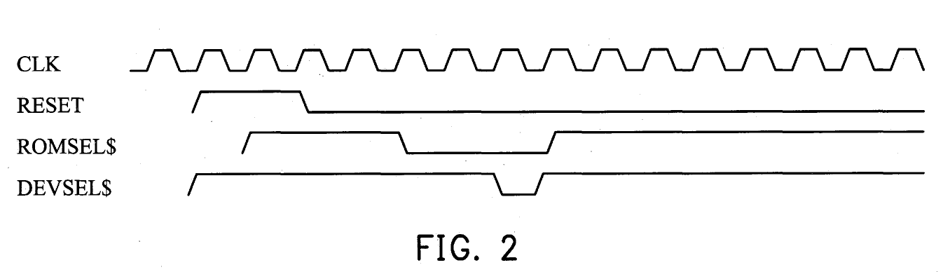

FIG. 2 shows how the represented signals initialize the computer system by the BIOS ROM 16 or the debugging system respectively. First it should be noted that the specification for the PCI bus indicates the various signals that are available on the PCI bus at the MC/PBHB logic chip 20. Only the signals that are relevant to the present invention are shown in FIG. 2 in various configurations.

CLK indicates the clock signal which is available from the system, and RESET indicates a reset signal which on reset first goes high and then defaults low.

If the CPU routes a data request to the local bus 12 for a read cycle of the ROM 16 (normal mode) or the debugging card 24 (debugging mode), the ROMSEL$ provided by the MC/PBHB activates the logic chip 20. As used herein and according to convention, a “$” after a signal designation means “active low”. The address of the directed device (ROM or debugging card) will be presented on the PCI bus according to PCI bus protocol, together with control signals to indicate that a memory read cycle is requested. According to PCI bus protocol, the directed device must activate the DEVSEL$ contact, within three clock cycles for an active decode, after the address phase for that cycle. Thus, when the CPU operates in the normal mode, the PCI-to-expansion bus bridge 28 uses ROMSEL$ signal driven from the MC/PBHB as an address decode to allow a DEVSEL$ within the three clock cycles after the address phase and retrieves the BIOS code in the ROM 16 corresponding to the address for loading the BIOS code in the CPU 10. On the other hand, when the CPU operates in the debugging mode, the PCI-to-expansion bus bridge 28 does not respond to ROMSEL$ signal but instead, the interface card 24 responds to ROMSEL$ signal with a DEVSEL$ within the three clock cycles after the address phase and retrieves its own BIOS code corresponding to the address for loading the BIOS code in the CPU 10.

Accordingly, from the previous description, it is noted that the data request for the BIOS code is routed to the debugging system when the CPU 10 is switched to debugging mode. The debugging system takes the place of the south bridge 28 to respond to the signal ROMSEL$ and loads the BIOS code stored in the debugging system in the CPU 10. Thus, even if the BIOS code in the ROM 16, the ROM 16 or the south bridge 28 fails, it can be skipped by switching the CPU 10 to the debugging mode and the computer system is initialized by the debugging system. Further, the debugging card 24 may be connected to another computer system 4 through which the BIOS code in the debugging card 24 can be programmed.

Initializing the computer system by the debugging system, has the following advantages. Software applications may be installed in the computer system 4 to read data in the register of the CPU 10 during initialization. Conventionally, it is possible to read register data only by logic analysis or signal probing. If the south bridge 28 and ROM 16 function normally but the BIOS code in the ROM 16 fails, the BIOS code may be read by the computer system 4 through the debugging card for debugging. If the south bridge 28 and ROM 16 function normally but the BIOS code in the ROM 16 fails, the ROM 16 may be reprogrammed through the computer system 4.

In conclusion, the present invention provides a computer system capable of being initialized by a BIOS debugging card. The data request for BIOS code is routed to the debugging card when the CPU 10 is switched to the debugging mode. The debugging card on the PCI bus, instead of the south bridge, responds to the data request from the CPU, which skips the ROM storing the BIOS code. Thus, even if the BIOS code or ROM fails, the system can be initialized through the debugging card.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of initializing a computer system equipped with a debugging system, wherein the computer system has a CPU, a local, peripheral and expansion bus, a first and second bridge, and a ROM coupled to the expansion bus and storing a first BIOS code, and the debugging system is coupled to the peripheral bus, the method comprising the steps of:
operating the CPU in a normal mode wherein first data requests directed to the ROM are routed to the local bus by the CPU;
operating the CPU in a debugging mode wherein second data requests directed to the debugging system are routed to the local bus by the CPU;
transferring one of the data requests from the local bus to the peripheral bus via the first bridge;
responding via the second bridge to the first data requests on the peripheral bus with the first BIOS code stored in ROM to be loaded in the CPU; and
responding via the debugging system to the second data requests on the peripheral bus with the second BIOS code stored therein to be loaded in the CPU.

2. The method as claimed in claim 1, wherein the second BIOS code is programmed by the debugging system.

3. The method as claimed in claim 2, wherein the debugging system comprises:
an interface card coupled to the peripheral bus; and
a second computer system coupled to the interface card.

4. The method as claimed in claim 1 further comprising the step of:
when the CPU is switched to the debugging mode, retrieving and displaying contents of registers in the CPU via the debugging system.

5. The method as claimed in claim 1 further comprising the step of:
when the CPU is switched to debugging mode, reading the first BIOS code from the ROM by the debugging system through the second bridge.

6. The method as claimed in claim 1 further comprising the step of:
when the CPU is switched to debugging mode, overwriting the first BIOS code in the ROM with the second BIOS code by the debugging system through the second bridge.

7. The method as claimed in claim 1, wherein switching between the normal and debugging mode is performed by enabling and disabling an A20 gate of the CPU respectively.

8. The method as claimed in claim 1, wherein the peripheral and expansion bus are a PCI and an ISA bus, and the first and second bridge are a north and south bridge, respectively.

9. The method as claimed in claim 1, wherein the second bridge responds the first data requests by sending a device select signal to the peripheral bus, decoding addresses carried in the first data requests and retrieving the first BIOS code in the ROM corresponding to the addresses.

10. The method as claimed in claim 1, wherein the debugging system responds to the second data requests by sending a device select signal to the peripheral bus, decoding addresses carried in the second data requests and retrieving the second BIOS code therein corresponding to the addresses.

11. A computer system capable of being initialized by a debugging system, comprising:
a CPU switched between a normal mode wherein first data requests are routed to the local bus by the CPU and a debugging mode wherein second data requests directed to the debugging system are routed to the local bus by the CPU;
a local, peripheral and expansion bus, wherein the CPU routes one of the data requests to the local bus and the debugging system is coupled to the peripheral bus;
a ROM coupled to the expansion bus and storing first BIOS code, to which the first data requests are directed;
a first bridge transferring one of the data requests from the local to the peripheral bus; and
a second bridge responding the first data requests on the peripheral bus with the first BIOS code in the ROM to be loaded in the CPU;
wherein said debugging system responds the second data requests with a second BIOS code and loads the second BIOS code into the CPU.

12. The computer system as claimed in claim 11, wherein the second BIOS code are programmed by the debugging system.

13. The computer system as claimed in claim 12, wherein the debugging system comprises:
an interface card coupled to the peripheral bus; and
a second computer system coupled to the interface card.

14. The computer system as claimed in claim 11, wherein the debugging system retrieves and displays contents of registers in the CPU when the CPU is switched to debugging mode.

15. The computer system as claimed in claim 11, wherein the debugging system reads the first BIOS code from the ROM through the second bridge when the CPU is switched to debugging mode.

16. The computer system as claimed in claim 11, wherein the debugging system overwrites the first BIOS code in the ROM with the second BIOS code through the second bridge when the CPU is switched to debugging mode.

17. The computer system as claimed in claim 11, wherein the CPU has an A20 gate and is switched between the normal mode and debugging mode by enabling and disabling the A20 gate.

18. The computer system as claimed in claim 11, wherein the peripheral and expansion bus are a PCI and an ISA bus, and the first and second bridge are a north and south bridge, respectively.

19. The computer system as claimed in claim 11, wherein the second bridge responds to first data requests by sending a device select signal to the peripheral bus, decoding addresses carried in the first data requests and retrieving the first BIOS code in the ROM corresponding to the addresses.

20. The computer system as claimed in claim 11, wherein the debugging system responds to second data requests by sending a device select signal to the peripheral bus, decoding addresses carried in the second data requests and retrieving the second BIOS code therein corresponding to the addresses.
